(19) United States
(12) Patent Application Publication
(10) Pub. No.: US 2016/0156294 A1
(43) Pub. Date: Jun. 2, 2016

(54) MOTOR DRIVING MODULE

(71) Applicant: ELECTRONICS AND TELECOMMUNICATIONS RESEARCH INSTITUTE, Daejeon (KR)

(72) Inventors: Sewan HEO, Daejeon (KR); Minki KIM, Daejeon (KR); Jung Hee SUK, Daejeon (KR); Yil Suk YANG, Daejeon (KR); Jimin OH, Daejeon (KR)

(73) Assignee: ELECTRONICS AND TELECOMMUNICATIONS RESEARCH INSTITUTE, Daejeon (KR)

(21) Appl. No.: 14/788,766

(22) Filed: Jun. 30, 2015

(30) Foreign Application Priority Data
Nov. 28, 2014 (KR) 10-2014-0168452

(51) Int. Cl. H02P 6/18

(52) U.S. Cl. CPC H02P 6/182

(57) ABSTRACT

Provided is a motor driving module for controlling a motor including a rotator and a stator, which includes a motor driving unit controlling a plurality of voltages applied to the motor on a basis of a position signal indicating a position of the rotator in response to an external control signal, an analog-to-digital converter detecting a plurality of phase currents applied to the motor to output a plurality of phase current signals, and a position estimating unit detecting the rotator position to output the position signal on a basis of the plurality of phase current signals, and a position calculating unit detecting the rotator position to output the position signal on a basis of the plurality of synchronized phase current signals.

### CROSS-REFERENCE TO RELATED APPLICATIONS

This U.S. non-provisional patent application claims priority under 35 U.S.C. §119 of Korean Patent Application No. 10-2014-0168452, filed on Nov. 28, 2014, the entire contents of which are hereby incorporated by reference.

### BACKGROUND OF THE INVENTION

The present invention disclosed herein relates to a motor system, and more particularly, to a motor driving module driving a brushless direct current (BLDC) motor system.

A motor is a device for converting electric energy into mechanical energy by using a force applied to a current within a magnetic field. Motors are classified into AC motors and DC motors according to a type of input power. The AC motor rotates a rotator by supplying a current to stator windings to change a magnetic field. The DC motor rotates a rotator by supplying a constant current to the rotator. At this point, the DC motor allows the current to flow in a certain direction regardless of a position of the rotator by using a brush.

Recently, with the development of a power electronic control technique, a BLDC motor is provided without a brush by using an electronic switching technique. Since the BLDC motor does not use a brush, there is not a limitation caused by heat generation due to mechanical friction and abrasion of the brush.

Driving methods of a BLDC motor is classified into a square wave voltage driving method and a sinusoidal voltage driving method. The square wave driving method has a simple circuit configuration and a simple driving method, while having a large vibration or noise. The sinusoidal driving method has a complex circuit configuration and a complex driving method, while having a small vibration and noise. Both of the above-described square wave driving method and square wave driving method detect a rotator position of a motor and drive the BLDC motor based on the detected rotator position.

The rotator position of the BLDC motor may be detected by using position sensors such as a hall sensor. The hall sensor is a component for detecting a rotator position by using a magnetic field method. Since the hall sensor is attached to the outside or inside of the motor, a volume or manufacturing cost of the motor increases.

To address the above-described limitations, a sensorless BLDC motor is used. The sensorless BLDC motor may measure or estimate a back electro-motive force (BEMF) generated during being driven and detect a rotator position. For example, when a sensorless

BLDC motor is driven using a square wave driving method, a motor driving module may measure a BEMF of the sensorless BLDC motor to detect a rotator position. On the contrary, when a sensorless BLDC motor is driven using a sinusoidal voltage driving method, the motor driving module is difficult to directly detect the BEMF of the sensorless BLDC motor. However, the motor driving module may detect an equivalent model, driving voltage and driving current of the BLDC motor to estimate the BEMF and detect a rotator position based on the estimated BEMF.

The equivalent model of the BLDC motor may be formed based on motor parameters measured before driving the motor. The driving voltage may be determined by an internal algorithm during driving the BLDC motor. A current flowing through the BLDC motor is measured during driving the BLDC motor and the measured current is used as a driving current. At this point, the current flowing through the BLDC motor may be measured through a sensor and used through analog-to-digital conversion. Since an analog-to-digital converted current signal is a discontinuous signal, accuracy of the rotator position estimation may become lowered.

### SUMMARY OF THE INVENTION

The present invention provides a motor driving module having improved accuracy of a motor control by converting detected phase current signals into continuous signals.

Embodiments of the present invention provide motor driving modules for controlling a motor including a rotator and a stator. The motor driving module includes: a motor driving unit controlling a plurality of voltages applied to the motor on a basis of a position signal indicating a position of the rotator in response to an external control signal; an analog-to-digital converter detecting a plurality of phase currents applied to the motor to output a plurality of phase current signals; and a position estimating unit detecting the rotator position to output the position signal on a basis of the plurality of phase current signals, wherein the position estimating unit includes: a phase locked loop generating a plurality of synchronized sinusoidal signals on a basis of the plurality of phase current signals; a Kalman filter generating a plurality of synchronized phase current signals on a basis of the plurality of phase current signals and the plurality of synchronized sinusoidal signals; and a position calculating unit detecting the rotator position to output the position signal on a basis of the plurality of synchronized phase current signals, and wherein the plurality of phase current signals are discontinuous signals, and the plurality of synchronized phase current signals are continuous signals.

In some embodiments, the motor driving unit may include: a reference voltage generating unit generating a reference voltage; a control unit controlling the reference voltage generating unit on a basis of the control signal and the position signal; and a pulse width modulation (PWM) unit generating a plurality of switching signals on a basis of the reference voltage, wherein the motor driving module further includes a PWM inverter generating the plurality of voltages on a basis of the plurality of switching signals.

In other embodiments, the position estimating unit may include a back electro-motive force (BEMF) estimating unit estimating a BEMF of the motor on a basis of the plurality of synchronized phase current signals and the reference voltage.

In still other embodiments, the BEMF may be estimated as a continuous signal.

In even other embodiments, the position calculating unit may output the position signal on a basis of the estimated BEMF.

In yet other embodiments, the reference voltage generating unit may output the reference voltage corresponding to the position signal according to a control of the control unit.

In further embodiments, the phase locked loop may include: a first transformer performing a coordinate transform on a basis of the plurality of phase current signals and a rotation angle to output rotating coordinate signals; an integrator outputting the rotation angle on a basis of any one signal of the rotating coordinate signals, and a reference angular speed and reference synchronized position signal according to the control signal; and a second transformer performing an inverse coordinate transform on a basis of synchronized rotating coordinate signals different from the rotating coordinate signals and the rotation angle, and outputting the plurality of synchronized sinusoidal signals.

In still further embodiments, the first transformer may include: a Clark transformer transforming the plurality of phase current signals into stationary coordinate signals to output stationary coordinate signals; and a Park transformer transforming the stationary coordinate signals into the rotating coordinate signals to output the rotating coordinate signals, and the second transformer may include: an inverse Park transformer transforming the synchronized rotating coordinate signals into the stationary coordinate signals on a basis of the rotation angle to output the synchronized stationary coordinate signals; and an inverse Clark transformer transforming the synchronized stationary coordinate signals into the plurality of sinusoidal signals.

In even further embodiments, the plurality of synchronized sinusoidal signals may have identical phases to those of the plurality of phase current signals.

In yet further embodiments, the motor may be a brushless direct current (BLDC) motor.

In yet still further embodiments, the plurality of voltages may be three phase voltages, and the plurality of phase currents may be three phase currents.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a block diagram illustrating a brushless DC (BLDC) motor according to an embodiment of the present invention;

FIG. 2 is a block diagram illustrating in detail the motor system of FIG. 1;

FIG. 3 is a block diagram illustrating in detail the position estimating unit of FIG. 1;

FIG. 4 is a block diagram illustrating in detail the SRF PLL and Kalman filter of FIG. 3;

FIGS. 5 and 6 are graphs showing a phase current signal and a synchronized phase current signal;

FIG. 7 is a graph showing an output of the position calculating unit of FIG. 3;

and

FIG. 8 is a flowchart illustrating an operation method of the motor driving module of FIG. 1.

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

Hereinafter, embodiments of the present invention will be described in detail with reference to the accompanying drawings so that the present invention can be easily practiced by those skilled in the art.

A sensorless brushless DC (BLDC) motor detects a position of a rotator included in the BLDC motor and is controlled based on the detected rotator position. A BLDC motor system according to the present invention may detect discontinuous phase current signals through a sampling and A/D converter from phase currents flowing to the BLDC motor, and detect a back electro-motive force (BEMF) by filtering the detected phase current signals into continuous phase signals. The BLDC motor system may estimate a rotator position based on the detected BEMF and control the BLDC motor by generating a reference signal on the basis of the estimated position. Accordingly, since the BEMF, rotator position and reference signal are detected, estimated, and generated as continuous signals over a time, control reliability of the BLDC motor system may be improved.

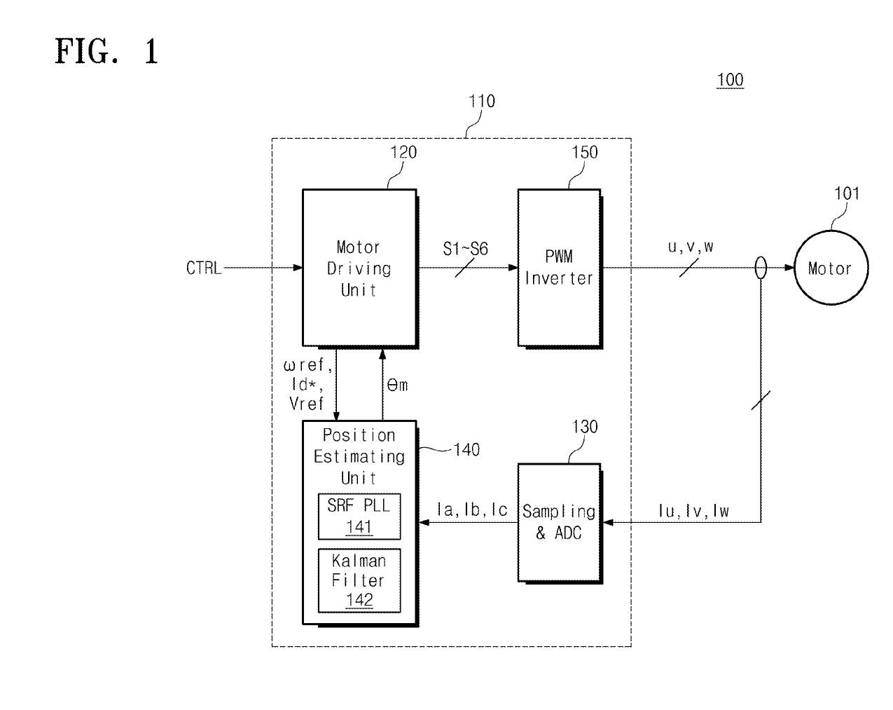

FIG. 1 is a block diagram illustrating a brushless DC (BLDC) motor according to an embodiment of the present invention. Referring to FIG. 1, a BLDC motor 100 includes a motor driving module 110 and a motor 101. In exemplary embodiments, the motor 101 may be a BLDC motor.

The motor driving module 110 may drive a motor 101 in response to a control signal CTRL. For example, the control signal CTRL may include information such as a target torque or a target speed of the motor 101. The motor driving module 110 may measure phase currents Iu, Iv, and Iw provided to the motor 101 and provide three phase voltages u, v, and w to the motor 101 on the basis of the measured phase currents Iu, Iv, and Iw and the control signal CTRL.

As a more detailed example, the motor driving module 110 include a motor driving unit 120, a sampling and analog-to-digital converter 130 (hereinafter, A/D converter), a position estimating unit 140, and a pulse width modulation inverter 150. The motor driving unit 120 may deliver a reference voltage Vref, a reference speed ωref, and a reference synchronized position signal Id* to the position estimating unit 130 in response to the control signal CTRL.

The A/D converter 130 may periodically sample the phase currents Iv. Iu, and Iw to output as the phase current signals Ia, Ib, and Ic. For example, the phase current signals Ia, Ib, and Ic may be signals indicating the three phase currents and may be discontinuous signals. For example, the discontinuous signals may indicate discrete signals.

The position estimating unit 140 may receive the phase current signals Ia, Ib, and Ic from the A/D converter 130 and detect the rotator position of the motor 101 based on the received phase signals Ia, Ib, and Ic, and the signals Vref, ωref, and Id* received from the motor driving unit 120, and output a position signal θm. For example, the position signal θm indicates an electric position of the rotator.

For example, the position estimating unit 140 may include a synchronized reference frame phase locked loop (SRF PLL) 141 and a Kalman filter 142.

The SRF PLL 141 may generate a synchronized sinusoidal signal having identical phases to those of the phase signals (Ia, Ib, Ic) on the basis of the phase signals Ia, Ib, and Ic, and the signals ωref and Id* received from the motor driving unit 120. The Kalman filter 142 may generate synchronized phase signals having identical phases and amplitudes to those of the phase current signals Ia, Ib, and Ic on the basis of the phase signals la, Ib, and Ic, and synchronized sinusoidal signals. For example, the synchronized phase current signals may be continuous signals.

The position estimating unit 140 may estimate a back electro-motive force

(BEMF) of the motor 101 on the basis of the synchronized phase current signals and detect a rotator position of the motor 101 on the basis of the estimated BEMF. The position estimating unit 140 may transmit the position signal θm indicating the detected rotator position to the motor driving unit 120.

The motor driving unit 120 may generate a reference voltage Vref according to the received position signal θm. The motor driving unit 120 may generate a plurality of switching signals Si to S6 on the basis of the reference voltage Vref to transmit the generated switching signals S1 to S6 to the PWM inverter 150.

The PWM inverter 150 may provide the three phase voltages u, v, and w to the motor 101 in response to the received switching signals S1 to S6. For example, when the motor 101 is driven based on the three phase voltages, the PWM inverter 150 may be implemented with six power switch elements, and each of the six switching elements may be driven by the switching signals, respectively. However, the scope of the present invention is not limited hereto.

For example, the phase current signals Ia, Ib, and Ic output from the A/D converter 130 may be discontinuous signals (or discrete signals). In this case, since the position signal θm output from the position estimating unit 130 is also discontinuously formed, a control on the motor 101 may not be precisely performed.

However, according to an embodiment of the present invention, since the position estimating unit 130 generates the synchronized phase current signals (namely, continuous signals) having identical phases and amplitudes to those of the discontinuous signals Ia, Ib, and Ic by using the SRF PLL 141 and the Kalman filter 142, the position signal θm output from the position estimating unit 130 may be continuous signals. Accordingly, accuracy of the control of the motor 101 can be improved.

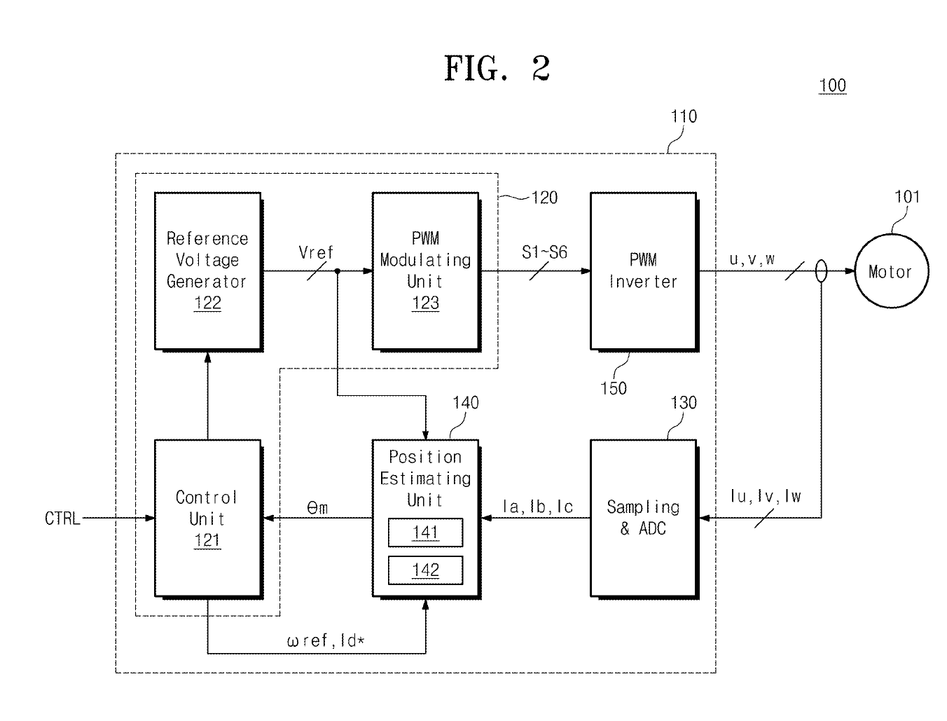

FIG. 2 is a block diagram illustrating in detail the motor system of FIG. 1. For concise description, detailed descriptions for components described in relation to FIG. 1 are omitted. Referring to FIGS. 1 and 2, the motor system 100 includes the motor driving module 110 and the motor 101. The motor driving module 110 includes the motor driving unit 120, the A/D converter 130, the position estimating unit 140, and the PWM inverter 150.

The motor driving unit 120 includes the control unit 121, a reference voltage generator 122, and a PWM modulating unit 123. The control unit 121 may transmit a reference speed ωref, and a reference synchronized position signal Id* to the position estimating unit 130 in response to a control signal CTRL. For example, the reference speed ωref, and the reference synchronized position signal Id* may be determined based on a target speed and target torque included in the control signal CTRL.

The control unit 121 may receive the position signal θm from the position estimating unit 140 and control the reference voltage generator 122 on the basis of the received position signal θm. For example, the control unit 121 may control a phase of the reference voltage Vref output from the reference voltage generator 122 on the basis of the received position signal θm. Alternatively, the control unit 121 may control the reference voltage generator 122 to output a voltage level corresponding to the position signal θm as the reference voltage Vref.

For example, the reference voltage Vref may be transmitted to the position estimating unit 140. The position estimating unit 130 may estimate a back electro-motive force (BEMF) of the motor 101 on the basis of the received reference voltage Vref.

The PWM modulating unit 123 may receive the reference voltage Vref from the reference voltage generator 122 and output a plurality of switching signals S1 to S6 by comparing the received reference voltage Vref and a carrier wave. For example, the carrier wave may be a signal having a pre-determined frequency and amplitude according to a PWM modulation method. For example, the carrier wave may include a waveform of a triangle wave, square wave, or sawtooth wave.

The PWM inverter 130 may receive the plurality of switching signals S1 to S6, generate three phase voltages u, w, and w on the basis of the received plurality of switching signals S1 to S6.

For example, according to the present invention, the phase currents Ia, Ib, and Ic output from the A/D converter 130 are discontinuous signals, and the position signal θm output from the position estimating unit 140 and the reference voltage Vref output from the reference voltage generator 122 may be continuous signals.

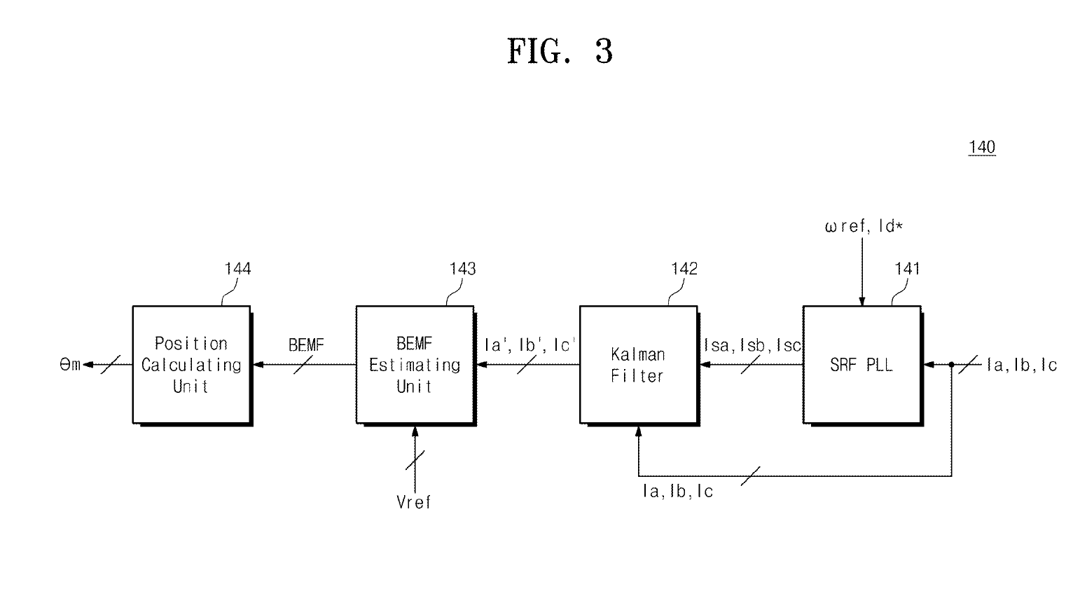

FIG. 3 is a block diagram illustrating in detail the position estimating unit of FIG. 1. Referring to FIGS. 2 and 3, the position estimating unit 140 includes a SRF PLL 141, a Kalman filter 142, a BEMF estimating unit 143, and a position calculating unit 144.

The SRF PLL 141 may receive phase current signals Ia, Ib, and Ic and generate synchronized sinusoidal signals Isa, Isb and Isc having identical phases to those of the received phase current signals Ia, Ib, and Ic. For example, the SRF PLL 141 may generate the synchronized sinusoidal signals Isa, Isb, and Isc having identical phases to those of phase current signals Ia, Ib, and Ic on the basis of the phase current signals Ia, Ib, and Ic, the reference synchronized angular speed ωref and the reference synchronized position signal Id*. For example the synchronized sinusoidal signals Isa, Isb, and Isc may be continuous signals.

The Kalman filter 142 may receive the synchronized sinusoidal signals Isa, Isb, and Isc and phase current signals Ia, Ib, and Ic, and generate synchronized phase current signals Ia′, Ib′, and Ic′ on the basis of the received signals. For example, the synchronized phase current signals Ia′, Ib′, and Ic′ may have identical phases and amplitudes in comparison to the phase current signals Ia, Ib, and Ic.

For example, the phase current signals Ia, Ib, and Ic may be discontinuous signals but the synchronized phase current signals Ia′, Ib′, and Ic′ may be continuous signals.

The BEMF estimating unit 143 may estimate the BEMF of the motor 101 on the basis of the synchronized phase current signals Ia′, Ib′, and Ic′. For example, the BEMF estimating unit 133 may include information on a motor model modeled based on parameters of the motor 101. The BEMF estimating unit 133 may estimate the BEMF of the motor on the basis of information on the motor model, the synchronized phase current signals Ia′, Ib′, and Ic′ and the reference voltage Vref. For example, a u phase BEMF generated from the motor 101 may be identical to Equation (1).

$${E}_{u} = ( {V}_{u} - {V}_{n} ) - L \frac{d {i}_{u}}{d t} - {R}_{u} {i}_{u} \qquad ( 1 )$$

Referring to Equation (1), Eᵤ denotes a u phase BEMF, Vᵤ denotes a u phase voltage level applied to the motor 101, Vₙ denotes a voltage of a neutral point, L denotes an inductance value included in the motor 101, Rᵤ denotes a u phase resistance value, and iᵤ denotes a u phase current.

At this point, the u phase voltage Vᵤ may be determined from the reference voltage Vref, and the inductance value L and resistance value R may be values measured in advance before driving the motor 101. The u phase current iᵤ may be determined from the continuous phase current signals Ia′, Ib′, and Ic′.

In other words, as described above, the BEMF estimating unit 143 may estimate the BEMF generated from the motor 101 on the basis of the pre-determined motor model, reference voltage Vref, and continuous phase current signals Ia′, Ib′, and Ic′. In exemplary embodiments, the BEMF may be three phase BEMFs.

The position calculating unit 144 may detect a position of a rotator included in the motor 101 on the basis of the estimated BEMF. For example, the estimated BEMF includes position information on the rotator. A phase of the estimated BEMF may indicate an electric position of the rotator. The position calculating unit 134 may output a position signal θm on the basis of the detected position.

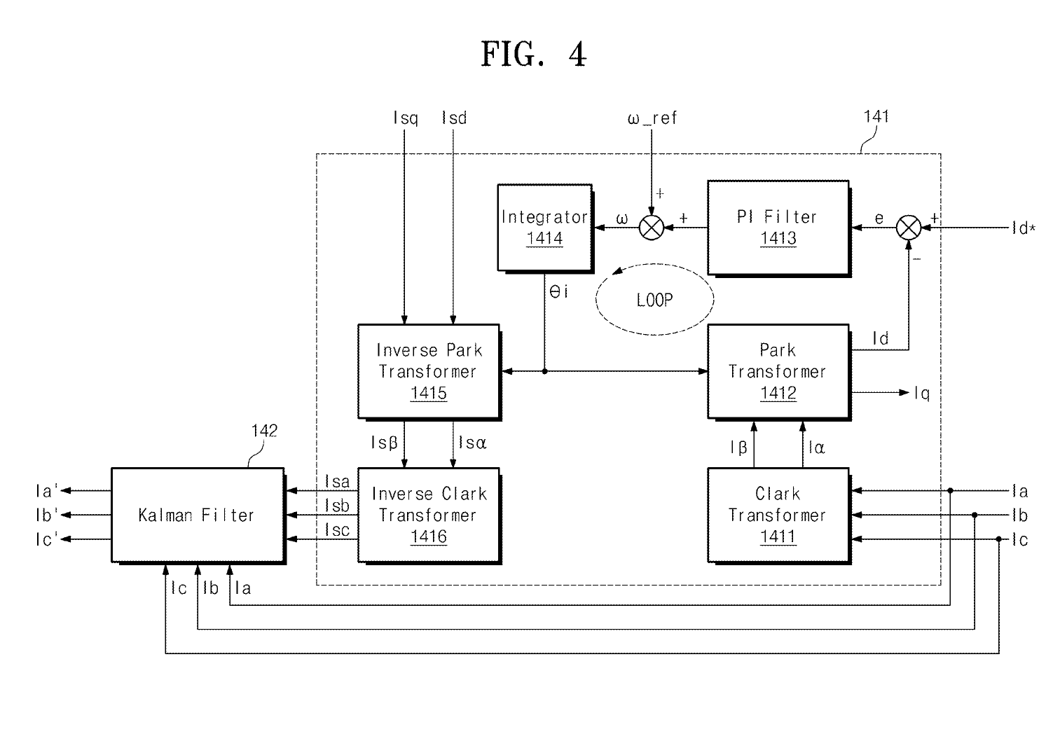

FIG. 4 is a block diagram illustrating in detail the SRF PLL and Kalman filter of FIG. 3. Referring to FIGS. 3 and 4, the SRF PLL 141 includes a Clark transformer 1411, a

Park transformer 1412, a PI filter 1413, an integrator 1414, an inverse Part transformer 1415, and an inverse Clark transformer 1416.

The Clark transformer 1411 may receive the phase current signals Ia, Ib, and Ic, and transform the received phase current signals Ia, Ib, and Ic into stationary rectangular coordinate to generate stationary coordinate signals Iα and Iβ. The stationary coordinate signals Iα and 1β are transmitted to the Park transformer 1412.

The Park transformer 1412 may receive the stationary coordinate signals Iα and 1β, and transform the received stationary coordinate signals Iα and 1β into rotating coordinate to generate rotating coordinate signals Id and Iq. For example, a d-axis signal Id of the rotating coordinates denotes a current signal on the same axis as that of a magnetic flux of the rotator.

For example, the Clark transformer 1411 and Park transformer 1412 may be transformers for direct-quadrature (DQ)-transforming the three phase current signals. For example, the Clark transformer 1411 and Park transformer 1412 may be transformers for transforming the three phase current signals into two phase current signals.

A difference e between the d-axis component Id and the reference synchronized position signal Id* and d-axis signal Id of the rotating coordinate signals Id and Iq is provided to the PI filter 1413. The difference e may be filtered by the PI filter 1413 and the filtered difference e is added to the reference angular speed ω_ref to become an angular speed signal ω. The angular speed signal ω is integrated by the integrator 1414 to be a rotation angle θi.

The rotation angle θi indicates phases of the phase current signals Ia, Ib, and Ic. The rotation angle θi is provided to the Park transformer 1412 and the Park transformer 1412 transforms the stationary coordinate signals Iα and 1β into the rotating coordinate signals on the basis of the rotation angle θi. For example, the rotation angle θI become stabilized through a loop.

The stabilized angle θi is provided to the inverse Park transformer 1415. The inverse Park transformer 1415 may transform synchronized rotating coordinate signals Isq and Isd into stationary coordinate signals. For example, the synchronized rotating coordinate signals Isq and Isd may be rotating coordinate signals on the basis of an arbitrary sinusoidal signal. Alternatively, the synchronized rotating coordinate signals Isq and Isd may be rotating coordinate signals on the basis of a sinusoidal signal having an angular speed of the reference synchronized speed ω_ref.

The synchronized stationary coordinate signals Isα and Isβ transformed by the inverse park transformer 1415 are provided to the inverse Clark transformer 1416. The inverse Clark transformer 1416 may transform the synchronized stationary coordinate signals Isα and Isβ into the synchronized sinusoidal signals Isa, Isb, and Isc.

For example, since the inverse Park transformer 1415 performs coordinate-transformation for the synchronized rotating coordinate signals Isq and Isd on the basis of the rotation angle θi, the synchronized sinusoidal signals Isa, Isb, and Isc may have identical phases of the phase current signals Ia, Ib, and Ic.

For example, the inverse Clark transformer 1416 and inverse Park transformer 1415 may be transformers for inverse-transforming the DQ-transformed signals into three phase current signals. In other words, the inverse Clark transformer 1416 and inverse Park transformer 1415 may be transformers for transforming the two phase current signals into the three phase current signals.

The Kalman filter 142 may receive the synchronized sinusoidal signals Isa, Isb, and Isc and the phase current signals Ia, Ib, and Ic, and generate synchronized phase current signals Ia′, Ib′, and Ic′ on the basis of the received signals. For example, the synchronized phase current signals Ia′, Ib′, and Ic′ output from the Kalman filter 132 may have substantially identical phases and amplitudes in comparison to the phase current signals Ia, Ib, and Ic.

For example, the phase current signals Ia, Ib, and Ic may be discontinuous signals while the synchronized phase current signals Ia′, Ib′, and Ic′ may be continuous signals.

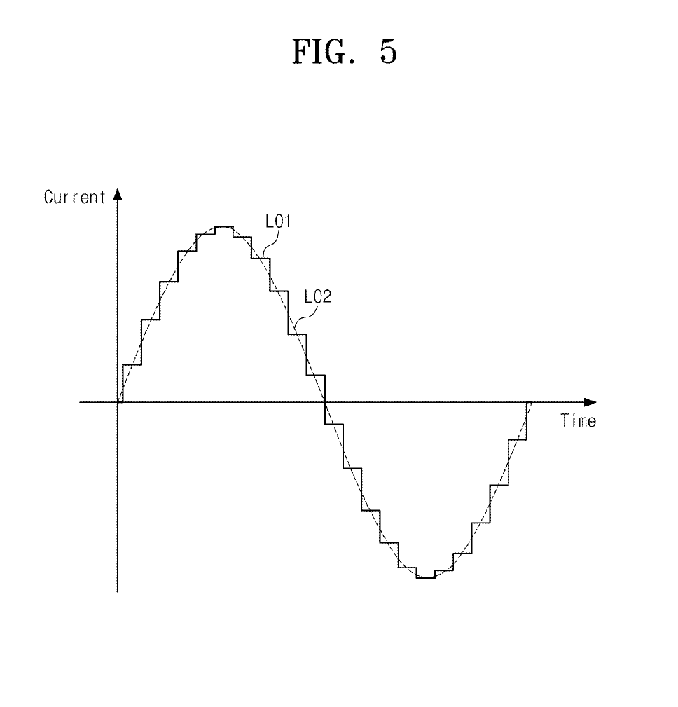

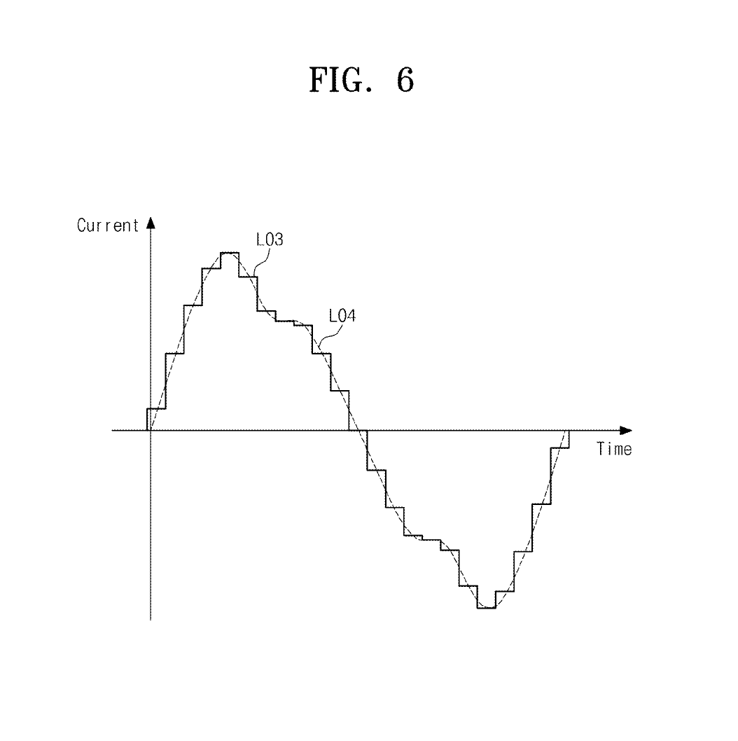

FIGS. 5 and 6 are graphs showing a phase current signal and a synchronized phase signal. For example, x-axes of FIGS. 5 and 6 indicate a time and y-axes indicate a current level. For conciseness of drawings, a phase current signal of one-phase is illustrated in FIGS. 5 and 6.

Referring to FIG. 5, the detected first phase current signal Ia, namely, a signal from the sampling and A/D converter 130 may be a discontinuous signal or discrete signal like a first line LO1. On the contrary, the synchronized first phase current Ia′ may be a continuous signal, namely, a sinusoidal signal like a second line LO2.

As illustrated in FIG. 5, since the phase current signals Ia′, Ib′, and Ic′ synchronized by the SRF PLL 131 and the filter 132 are continuous signals, accuracy of position estimation and control of the motor 101 is improved.

For example, the synchronized phase current signals Ia′, Ib′, and Ic′ may not be the sinusoidal signals. For example, as illustrated in FIG. 6, the detected first phase current signal Ia may be identical to a third line LO3. At this point, the synchronized phase current signal Ia′ may be identical to a fourth line LO4.

Unlike FIG. 5, the synchronized first phase signal Ia′ illustrated in FIG. 6 may not be a sinusoidal signal. For example, when the motor 101 is driven in a normal speed, namely, a constant speed, the synchronized phase current signals Ia′, Ib′, and Ic′ have a sinusoidal form. When the speed of the motor 110 is changed, a waveform of the phase current signal may be changed in a period of speed change. For example, at a certain time FIG. 6 (e.g., a point of inflection of the fourth line LO4), the speed of the motor 101 may be changed. At this point, the synchronized phase current signals Ia′, Ib′, and Ic′ may not have the sinusoidal form. However, although not having the sinusoidal form, since the synchronized phase current signals Ia′, Ib′, and Ic′ are continuous signals, accuracy of the position estimation and control of the motor 101 may be improved.

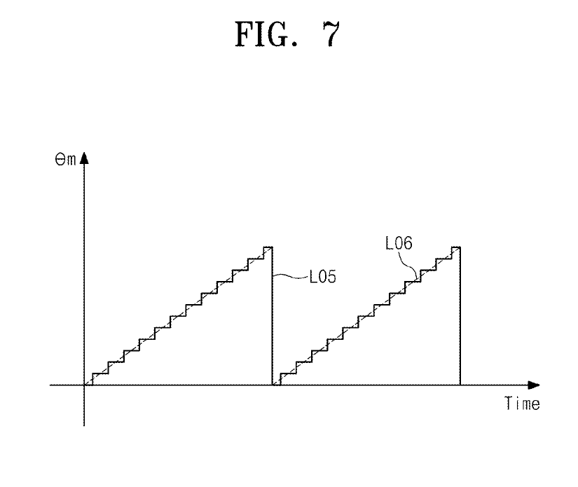

FIG. 7 is a graph showing an output of the position operation unit of FIG. 3. For example, in order to explain an effect of the embodiment of the present invention, outputs of the position calculating units according to a typical art and the present invention are described together.

Referring to FIGS. 3 and 7, the output, namely, a position signal estimated based on the discontinuous phase current signal of the position calculating unit according to the typical art is like a fifth line LO5. On the contrary, the output, namely, a position signal estimated based on the continuous phase current signal, is like a sixth line LO6.

As illustrated in FIG. 7, since the position signal that is an output of the position calculating unit 134 according to the present invention is continuous, the reference voltage generated based on the position signal may also have a continuous waveform. Accordingly, driving accuracy of the motor 101 is improved.

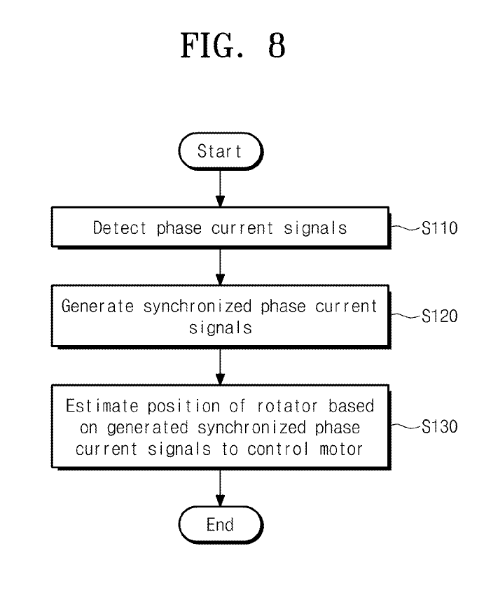

FIG. 8 is a flowchart illustrating an operation method of the motor driving module of FIG. 1. Referring FIGS. 1 and 8, in operation S110, the motor driving module 110 detects the phase current signals Ia, Ib, and Ic applied to the motor 101. At this point, the detected phase current signals Ia, lb, and Ic may be discontinuous signals.

In operation S120, the motor driving module 110 may generate the synchronized phase current signals Ia′, Ib′, and Ic′ having the same phases and amplitudes as those of the detected phase current signals Ia, lb, and Ic. For example, the motor driving module 110 may generate the synchronized phase current signals Ia′, Ib′, and Ic′ by using the SRF PLL 131 and the Kalman filter 132. The synchronized phase current signals Ia′, Ib′, and Ic′ may be the continuous signals.

In operation S130, the motor driving module 110 may estimate a rotator position of the motor 101 on the basis of the synchronized phase current signals Ia′, Ib′, and Ic′ and control the motor 101 on the basis of the estimated position.

According to an embodiment of the present invention, the motor driving module 110 may estimate the rotator position by transforming the detected phase current signals Ia, Ib, and Ic that are discontinuous signals into the synchronized phase current signals Ia′, Ib′, and Ic′ that are continuous signals. Accordingly, accuracy of estimating the rotator position and controlling the motor 101 is improved.

According to embodiments, a motor driving module converts phase currents used for detecting a rotator position into continuous phase current signals to become a rotator position signal and a position signal based reference voltage or continuous signal. Accordingly, a motor driving module having improved accuracy of motor control can be provided.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A motor driving module for controlling a motor comprising a rotator and a stator, the motor driving module comprising:
a motor driving unit controlling a plurality of voltages applied to the motor on a basis of a position signal indicating a position of the rotator in response to an external control signal;
an analog-to-digital converter detecting a plurality of phase currents applied to the motor to output a plurality of phase current signals; and
a position estimating unit detecting the rotator position to output the position signal on a basis of the plurality of phase current signals,
wherein the position estimating unit comprises:
a phase locked loop generating a plurality of synchronized sinusoidal signals on a basis of the plurality of phase current signals;
a Kalman filter generating a plurality of synchronized phase current signals on a basis of the plurality of phase current signals and the plurality of synchronized sinusoidal signals; and
a position calculating unit detecting the rotator position to output the position signal on a basis of the plurality of synchronized phase current signals, and
wherein the plurality of phase current signals are discontinuous signals, and the plurality of synchronized phase current signals are continuous signals.

2. The motor driving module of claim 1, wherein the motor driving unit comprises:
a reference voltage generating unit generating a reference voltage;
a control unit controlling the reference voltage generating unit on a basis of the control signal and the position signal; and
a pulse width modulation (PWM) unit generating a plurality of switching signals on a basis of the reference voltage,
wherein the motor driving module further comprises a PWM inverter generating the plurality of voltages on a basis of the plurality of switching signals.

3. The motor driving module of claim 2, wherein the position estimating unit comprises a back electro-motive force (BEMF) estimating unit estimating a BEMF of the motor on a basis of the plurality of synchronized phase current signals and the reference voltage.

4. The motor driving module of claim 3, wherein the BEMF is estimated as a continuous signal.

5. The motor driving module of claim 3, wherein the position calculating unit outputs the position signal on a basis of the estimated BEMF.

6. The motor driving module of claim 2, wherein the reference voltage generating unit outputs the reference voltage corresponding to the position signal according to a control of the control unit.

7. The motor driving module of claim 1, wherein the phase locked loop comprises:
a first transformer performing a coordinate transform on a basis of the plurality of phase current signals and a rotation angle to output rotating coordinate signals;
an integrator outputting the rotation angle on a basis of any one signal of the rotating coordinate signals, and a reference angular speed and reference synchronized position signal according to the control signal; and
a second transformer performing an inverse coordinate transform on a basis of synchronized rotating coordinate signals different from the rotating coordinate signals and the rotation angle, and outputting the plurality of synchronized sinusoidal signals.

8. The motor driving module of claim 7, wherein the first transformer comprises:
a Clark transformer transforming the plurality of phase current signals into stationary coordinate signals to output stationary coordinate signals; and
a Park transformer transforming the stationary coordinate signals into the rotating coordinate signals to output the rotating coordinate signals, and
the second transformer comprises:
an inverse Park transformer transforming the synchronized rotating coordinate signals into the stationary coordinate signals on a basis of the rotation angle to output the synchronized stationary coordinate signals; and
an inverse Clark transformer transforming the synchronized stationary coordinate signals into the plurality of sinusoidal signals.

9. The motor driving module of claim 8, wherein the plurality of synchronized sinusoidal signals have identical phases to those of the plurality of phase current signals.

10. The motor driving module of claim 1, wherein the motor is a brushless direct current (BLDC) motor.

11. The motor driving module of claim 1, wherein the plurality of voltages are three phase voltages, and the plurality of phase currents are three phase currents.
